(19) United States
(12) Patent Application Publication
(10) Pub. No.: US 2026/0290901 A1
(43) Pub. Date: Sep. 24, 2026

(54) TRANSFORMING COMPLEX ANION-BASED SALTS TO SUPERCATIONIC CONDUCTORS

(71) Applicant: Toyota Motor Engineering & Manufacturing North America, Inc., Plano, TX (US)

(72) Inventors: Rana Mohtadi, Northville, MI (US); Oscar Tutusaus, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/696,522

(22) Filed: Jun. 3, 2026

Related U.S. Application Data
(63) Continuation-in-part of application No. 19/358,619, filed on Oct. 15, 2025.
Application No. 19/358,619 is a continuation of application No. 17/846,334, filed on Jun. 22, 2022, now Pat. No. 12,469,884.

(51) Int. Cl. H01M 10/0568; H01M 10/052; H01M 10/0562; H01M 10/39

(52) U.S. Cl. CPC H01M 10/0568; H01M 10/052; H01M 10/0562; H01M 10/399; H01M 2300/0048; H01M 2300/0065

(57) ABSTRACT

A solid-state electrolyte comprising a composite salt mixture comprising: a metal cation selected from the group consisting of Li⁺, Na⁺, K⁺, Mg²⁺, Ca²⁺, Zn²⁺, Al³⁺, and any combination thereof; and a plurality of weakly coordinating anions (WCAs) including 0.5 mole percent (mol %) to 90 mol % of each WCA present therein, each WCA including a same core group of atom(s) and differing from any other WCA in a number, a type, and/or a position of any substituent of the core group of atom(s), the composite salt mixture has a cationic conductivity that is one to four orders of magnitude greater than a cationic conductivity of a corresponding salt comprising the metal cation and any WCA of the plurality of WCAs alone. An electrochemical cell comprising: an anode, a cathode, and the solid-state electrolyte.

### CROSS-REFERENCE TO RELATED APPLICATION

This application is a continuation-in-part application of currently pending U.S. patent application Ser. No. 19/358,619, filed on Oct. 15, 2025, which is a continuation application of U.S. patent application Ser. No. 17/846,334, filed on Jun. 22, 2022, both of which are incorporated herein in their entirety by reference.

### TECHNICAL FIELD

The present disclosure generally relates to electrolytes, and particularly to electrolytes for lithium, sodium, potassium, magnesium, calcium, zinc, or aluminum batteries.

### BACKGROUND

Solid-state electrolytes provide many advantages in secondary battery design, including mechanical stability, no volatility, and ease of construction. Typical inorganic solid-state electrolytes having high ionic conductivity are sulfide-based electrolytes. For example, Zhang et al. reported that the ionic conductivity for a sulfide electrolyte can exceed 25 mS/cm, which is advantageous for battery applications (Zhang Z et al., Energy Environ. Sci., 2018, 11, 1945). However, sulfide-based electrolytes suffer from the high propensity to form H₂S toxic gases upon exposure to low levels of moisture, which challenges their practical use. Other classes, such as polymeric and other organic electrolytes, have inferior ionic mobility at technologically relevant temperatures below 60° C.

Multiple families of inorganic all-solid-state electrolytes exist, some exhibiting superior ionic conductivities on the order of 10⁻⁴ to 10⁻³ S/cm at room temperature, a pivotal advancement toward the pursuit of viable all-solid-state batteries. Yet, to date, no material design has successfully balanced the high cationic mobility with other vital properties, including exceptional electrochemical stability, mechanical resilience, low density, and the incorporation of sufficiently abundant or non-rare-earth elements within their structural framework. Striking this delicate balance is especially critical for advancing next-generation beyond-Li-ion batteries, particularly those employing metallic anodes such as Li paired with 4 V class high-voltage cathodes. By contrast—and notwithstanding the use of undesired volatile solvents, liquid electrolytes superficially appear to present better alternatives due to a much wider design versatility. In liquids, high cation mobility in the order of 10⁻³ S/cm is comparatively straightforward to realize, thereby freeing the design space to tune other properties, such as their electrochemical stabilities, through molecular design and ligand engineering. Access to a broad design space has contributed significantly to the remarkable advancements achieved in Li metal anode/oxide cathode batteries. For example, tuning the chemical nature of molecules using fluorinated ligands in the electrolytes has enabled highly efficient Li cycling. However, from the perspective of practical application, the use of volatile solvents and C—F chemistries raises safety and environmental sustainability concerns, including associations with PFAS (“forever chemicals”).

The present disclosure addresses these issues with solid-state electrolytes, and other issues related to electrolytes.

### SUMMARY

In one form of the present disclosure, a solid-state electrolyte composition includes a composite salt mixture comprising: a metal cation selected from the group consisting of Li⁺, Na⁺, K⁺, Mg²⁺, Ca²⁺, Zn²⁺, Al³⁺, and any combination thereof; and a plurality of weakly coordinating anions (WCAs) comprising 0.5 mole percent (mol %) to 90 mol % of each WCA present therein, each WCA: including a same core group of atom(s); and differing from any other WCA thereof in a number, a type, and/or a position of a substituent of the core group of atom(s), the composite salt mixture having a cationic conductivity that is one to four orders of magnitude greater than a cationic conductivity of a corresponding salt including the metal cation and any WCA of the plurality of WCAs alone.

In another form of the present disclosure, an electrochemical cell includes: an anode, a cathode, and a solid-state electrolyte including a composite salt mixture comprising: a metal cation selected from the group consisting of Li⁺, Na⁺, K⁺, Mg²⁺, Ca²⁺, Zn²⁺, Al³⁺, and any combination thereof; and a plurality of WCAs comprising 0.5 mol % to 90 mol % of each WCA present therein, each WCA: including a same core grouping of atoms; and differing from any other WCA thereof in a number, a type, and/or a position of a substituent of the core group of atom(s), the composite salt mixture having a cationic conductivity that is one to four orders of magnitude greater than a cationic conductivity of a corresponding salt comprising the metal cation and any WCA of the plurality of WCAs alone.

In still another form of the present disclosure, methods include forming a composite salt mixture by mixing a plurality of salts using mechanochemical synthetic ball milling or solution-based synthesis, the plurality of salts comprising: a metal cation selected from the group consisting of Li⁺, Na+, K+, Mg2+, Ca2+, Zn2+, Al3+, and any combination thereof; and a plurality of WCAs comprising 0.5 mol % to 90 mol % of each WCA present therein, each WCA: including a same core group of atom(s); and differing from any other WCA thereof in a number, a type, and/or a position of a substituent of the core group of atom(s), the composite salt mixture including a cationic conductivity that is one to four orders of magnitude greater than a cationic conductivity of a corresponding salt comprising the metal cation and any WCA of the plurality of WCAs alone, and, optionally, heating the composite salt mixture at a temperature of 500° C. or less; optionally, homogenizing the composite salt mixture by ball milling; and forming a solid-state electrolyte comprising the composite salt mixture, optionally, by applying pressure to the composite salt mixture.

These and other features of the nearly solvent-free combined salt electrolyte and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 is an Arrhenius plot of cationic conductivity versus temperature for LiWCA-1, and a composite salt mixture of LiCB₁₁H₁₂ (“LiWCA-1”) and LiCB₁₁H₁₁F (“LiWCA-2”) according to the teachings of the present disclosure;

FIG. 2 is an Arrhenius plot of cationic conductivity versus temperature for LiWCA-1, and another composite salt mixture of LiWCA-1 and LiWCA-2 according to the teachings of the present disclosure;

FIG. 3 is a plot of cationic conductivity and activation energy versus % molar content of LiWCA-2 in a LiWCA-1-LiWCA-2 composite salt mixture;

FIG. 4 shows an electrochemical device according to the teachings of the present disclosure;

FIG. 5 is a plot of calculated cell volume versus % molar content of LiWCA-2 in a LiWCA-1-LiWCA-2 composite salt mixture; or LiWCA-3 in a LiWCA-1-LiCB₁₁H₁₀F₂ (“LiWCA-3”) composite salt mixture;

FIG. 6 is a prototypical crystal structure of a LiWCA-1-LiWCA-2 composite salt mixture with 60 molar % LiWCA-2, as shown by x-ray diffraction (XRD) at 30° C.; and

FIG. 7 is a prototypical crystal structure at 30° C. of a LiWCA-1-LiWCA-2 composite salt mixture with 70 molar % LiWCA-2, as shown by XRD at 30° C.

It should be noted that the figures set forth herein are intended to exemplify the general characteristics of the methods, algorithms, and devices among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

In an effort to overcome the issues related to sulfide-based electrolytes noted above, polymeric electrolytes and other organic electrolytes have been studied but found to exhibit inferior ionic mobility at technologically relevant temperatures below 60° C. And recently, boron cluster salts have been reported to possibly form superionic conductors at above 50° C., and for many of these salts at above 120° C. In some instances, these superionic conductor high-temperature phases can be stabilized at room temperature for limited boron cluster salts (e.g., see U.S. Pat. No. 10,553,897; Kim S. et al. Nature Communications 10:1081, 2019; Tang W. S. et al. ACS Energy Lett. 2016, 1, 659-664). However, such an approach is problematic as the ionic conduction property, which includes the activation energy, is dictated by the intrinsic property and structural features of the high-temperature phases. In fact, salts of boron clusters, and also most polymeric and other solid-state inorganic electrolytes, generally exhibit relatively high activation energies for cationic mobility at temperatures below 60° C., which in turn implies a strong effect of the temperature on cationic mobility—a property not desired for device operation. For example, the lowest activation energy for a room temperature superionic conductors based on boron cluster lithium cations has been reported to be greater than 0.29 eV (Kim S. et al., Nature Communications 10:1081, 2019). And the activation energy for Li boron cluster salts exceeded 0.31 eV for temperatures above 39° C. and increased to 0.74 eV as these electrolytes were cooled below 39° C. (Tang W. S. et al. ACS Energy Lett. 2016, 1, 659-664).

### Solid-State Electrolyte Compositions

Inspired by the design flexibility of liquid electrolytes, an analogous, tunable framework for inorganic solid-state electrolytes is disclosed. The key is to decouple ionic transport from stability by designing composite salt mixtures that preserve the parent WCA salts' chemical and electrochemical robustness while markedly boosting Li⁺ mobility, specifically by creating solid salt mixtures of metal cations and mixed-anions (incorporating the same anionic scaffold in two ligand-differentiated variants), which act as “solid solutions” (referred to herein as “composite salt mixtures”). This controlled mixing introduces lattice perturbations that promote fast cation transport without compromising structural integrity, thereby converting intrinsically stable yet poorly conductive (or insulating) salts with discrete WCAs into room-temperature superionic electrolytes. This paradigm is termed “Same Anion, Multifunctional Ionic (SAMI)” paradigm for all solid-state electrolytes (ASSEs). The SAMI paradigm enables high cationic mobility through weakening cation-anion interactions, which leads to opening diffusion pathways. Through careful selection of ligand nature and environment, co-optimization of ionic conductivity along with electrochemical and physical properties is possible. Composite Salt Mixtures/SAMIs

In an aspect, the present disclosure provides solid-state electrolyte compositions including a composite salt mixture based on the SAMI paradigm (the term “composite salt mixture” is used interchangeably herein with the term “SAMI”). A composite salt mixture (aka, a SAMI) includes a plurality of WCA salts (including a metal salt and a plurality of WCAs) as described herein.

### Metal Cations

In some embodiments, SAMIs may include various metal cations selected from the group consisting of Li⁺, Na⁺, K⁺, Mg²⁺, Ca²⁺, Zn²⁺, Al³⁺, and any combination thereof.

### Weakly Coordinating Anions (WCAs)

Composite metal salts of the present disclosure may include various weakly coordinating anions (WCAs) and combinations thereof. As used herein, the term “weakly coordinating anion” or “WCA” refers to a class of anions that interact only weakly with cations. For the purposes of this disclosure, a WCA is defined as an anion that satisfies at least one of the following criteria: (1) a superacid criterion wherein the WCA is the conjugate base of a superacid, defined herein as an acid having an acidity greater than that of 100% pure sulfuric acid (i.e., a Hammett acidity function H₀≤−12); (2) a structural criterion wherein the WCA possesses a molecular volume greater than that of the cyanide anion (CN⁻) and wherein the negative charge is delocalized over a plurality of atoms or is shielded by bulky substituents; or (3) an electrochemical stability criterion wherein the WCA is chemically stable against oxidation at a potential greater than 3.5 V versus a lithium reference electrode (Li⁰/Li⁺).

In some embodiments, SAMIs include a plurality of WCAs selected from the group consisting of boron cluster anions, non-cluster organoborate anions, sulfonylimide anions, phosphorus-based anions, sulfonate-based anions (including triflates), phosphorylimide-based anions, aluminate-based anions (including organoaluminates and alkoxyaluminates), and any combination thereof. In some embodiments, SAMIs include a plurality of WCAs selected from the group consisting of boron cluster anions, sulfonylimide anions, phosphate-based anions, triflate-based anions, phosphorylimide-based anions, organoborate-based anions, organoaluminate-based anions, haloaluminates, haloborates, and any combination thereof.

In some variations, a core group of atom(s) of a WCA is a single central atom, such as: the central phosphorus (P) atom of a phosphorus-based anion; the central sulfur (S) atom of a sulfonate-based anion; the central aluminum (Al) atom of an aluminate-based anion; or the central boron (B) atom of a non-cluster organoborate anion. In these variations, the “substituents” are the ligands coordinated to said central atom.

As used herein, the term “phosphorus-based anions” refers to anions comprising a central phosphorus atom coordinated by four to six ligands. Nonlimiting examples of phosphorus-based anions include hexafluorophosphate (PF₆⁻), difluorophosphate (PO₂F₂⁻), tris(oxalato)phosphate ([P(C₂O₄)₃]⁻), difluoro(oxalato)phosphate ([PF₂(C₂O₄)]⁻), perfluoroalkylphosphates such as tris(pentafluoroethyl)trifluorophosphate (FAP⁻), unsubstituted and substituted aryloxy/alkoxy phosphates or mixed fluoro/alkoxy derivatives like [PFₙ(OR)₍₆₋ₙ₎]⁻ (where R is a highly electron-withdrawing group, such as a fluorinated, chlorinated alkyl or aryl group), and any anions where the ligands are selected from fluorine, chlorine, oxygen, unsubstituted alkyls, or fluorinated or chlorinated alkyls.

As used herein, the term “sulfonate-based anions” refers to anions comprising a central sulfur atom bonded to three oxygen atoms and one organic or inorganic substituent (R—SO₃⁻). Nonlimiting examples of sulfonate-based anions include the triflate anion (trifluoromethanesulfonate, CF₃SO₃⁻), the fluorosulfonate anion (FSO₃⁻), the nonaflate anion (nonafluorobutanesulfonate), methanesulfonate (mesylate), p-toluene sulfonate (tosylate), and chemically related species where the R group is a linear or branched unsubstituted, chlorinated, or fluorinated alkyl chain.

As used herein, the term “aluminate-based anions” refers to anions comprising at least one aluminum atom coordinated by ligands. This definition explicitly includes mononuclear anions (a single central aluminum atom, typically tetrahedral) and polynuclear or bridged anions (two or more aluminum atoms linked by a bridging group). Nonlimiting examples include alkoxyaluminates and aryloxyaluminates, such as the tetrakis(hexafluoroisopropyloxy)aluminate anion ([Al(OCH(CF₃)₂)₄]⁻ or Al(Ohfip)₄⁻), tetrakis(perfluoro-tert-butoxy)aluminate anion ([Al(OC(CF₃)₃)₄]⁻), and bridged species such as the μ-fluorido-bis[tris(perfluaoro-tert-butoxy)aluminate]anion [(CF₃)₃CO)₃Al—F—Al(OC(CF₃)₃)₃]⁻ and other organoaluminates where the ligands are bulky, electron-withdrawing groups such as fluorinated alkoxides, fluorinated aryls, or halides. It also includes haloaluminates with the general formula AlX₄⁻ or AlX₆⁻, where X can be a simple halogen such as Cl—, Br—, F—, I—, or a combination thereof.

In some variations, a core group of atom(s) of a WCA is a multi-atom unit linking two functional groups, such as the sulfonyl-nitrogen-sulfonyl unit (—SO₂—N—SO₂— found in sulfonylimides); or the phosphoryl-nitrogen-phosphoryl unit (—PO—N—PO—); or a metal-bridge-metal unit such as the aluminum-fluoride-aluminum core (—Al—F—Al—) or the aluminum-oxygen-aluminum (—Al—O—Al—). In these embodiments, the “substituents” are the groups attached to the sulfur or phosphorus atoms of the core unit.

As used herein, the term “phosphorylimide-based anions” refers to anions containing a nitrogen atom bridging two phosphorus centers or a phosphorus and a sulfur center. Nonlimiting examples include anions of the general structure [(R₂PC)₂N]⁻, such as bis(fluorophosphonyl)imide.

As used herein, the term “sulfonylimide anions” refers to stable, delocalized anionic molecules with a general structure [(RSO₂)₂N]⁻ wherein the core is the —S—N—S— backbone. Nonlimiting examples include the bis(trifluoromethanesulfonyl)imide anion (TFSI- or [N(SO₂CF₃)₂]⁻), the bis(fluorosulfonyl)imide anion (FSI− or [N(SO₂F)₂)]⁻), the (fluorosulfonyl)(trifluoromethanesulfonyl)imide anion (FTFSI⁻), and cyclic sulfonylimides such as 1,3-disulfonylhexafluoropropylene imide.

In some variations, a core group of atom(s) of a WCA is a three-dimensional polyhedral structure, such as the cage of a boron cluster anion, which contains boron atoms (and optionally carbon atoms) at the vertices thereof (ligands at the periphery of the core may be halogens, or other groups).

As used herein, the term “boron cluster anion” refers to polyhedral boranes and carboranes (e.g., B12, CB11 cages), whereas the term “non-cluster organoborate anion” refers to a central boron atom coordinated fully or partially by four alkyl, alkoxy, aryl, aryloxy unsubstituted, partially substituted, fully substituted ligands including bulky ligands or simple halogens. Nonlimiting examples of non-cluster organoborate anions include tetrakis(pentafluorophenyl)borate ([B(C₆F)₄]⁻) and tetrakis[3,5-bis(trifluoromethyl)phenyl]borate ([BArF₄]⁻). For boron cluster anions, substituents may replace hydrogen atoms at the vertices.

Nonlimiting examples of boron cluster anions include borane anions (e.g., closo-borate anions, nido-borate anions, arachno-borate anions, and the like). In some variations, a boron cluster anion has a structure selected from the group consisting of: [B_{y}H_{(y-z)}R_{z}]², [B_{y}H_{(y-z-i)}R_{z}Xᵢ]²⁻, [CB(_{y-1})H_{(y-z)}R_{z}]⁻, [CB(_{y-1})H_{(y-z-i)}R_{z}Xᵢ]⁻, [C₂B_{(y-2)}H_{(y-t-1)}Rₜ]⁻, [C₂B_{(y-2)}H_{(y-t-1)}RₜXⱼ]⁻, [C₂B_{(y-3)}H_{(y-t)}Rₜ]⁻, [C₂B_{(y-3)}H_{(y-t-j)}RₜXⱼ]⁻, [C₂B_{(y-3)}H_{(y-t-1)}Rₜ]²⁻, and [C₂B_{(y-3)}H_{(y-t-i-1)}RₜXⱼ]²⁻, wherein: y is an integer within a range of 6 to 12; (z), or, when Xᵢ is present, (z+i), is an integer within a range of 0 to y; (t) or, when Xⱼ is present, (t+j), is an integer within a range of 0 to (y−1); X is F, Cl, Br, I, a halogenated alkyl group including CF₃, or a combination thereof; and R is a C1-C18 alkyl group selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof.

### Substituents of WCAs

WCAs may each have various positions of substituents. For example, in a borane anion ([B₁₂H₁₂]²⁻) or a carborane anion ([CB₁₁H₁₂]⁻), there are twelve vertex positions available for substitution. In the case of the carborane anion [CB₁₁H₁₂]⁻, the carbon atom is defined as position 1, the boron atom antipodal to the carbon is position 12, and the remaining boron atoms are arranged in two pentagonal belts (positions 2-6 adjacent to carbon, and positions 7-11 adjacent to the antipodal boron). Substituents may be placed selectively at the antipodal position (B-12), the lower belt (B-7 through B-11), the upper belt (B-2 through B-6), the carbon atom, or randomly distributed across all vertices. For aluminate-based anions, the “positions” correspond to the four coordination sites around the central aluminum atom; substituents may replace one, two, three, or all four of the ligands (e.g., replacing a perfluoro-tert-butoxy group with a fluorine atom to create a mixed-ligand species).

WCAs may each have various numbers of substituents (degree of substitution). In some variations, a first WCA has no substituents, while a second WCA has one or more substituents. In some variations, a first WCA has no substituents, a second WCA has one substituent, a third WCA has two substituents, and the like. In some variations, a first WCA of the plurality of WCAs has one to twelve substituents.

WCAs may each have various types of substituents. In some variations, a first WCA has a first type of substituent, while a second WCA has one or more different types of substituents. In some variations, a first WCA has a first type of substituent, a second WCA has a second type of substituent, a third WCA has a third type of substituent, and the like. In some variations, the plurality of WCAs has one to twelve types of substituents distributed therein. In some variations, a substituent is a hydrogen. In some variations, a substituent is a halogen atom substituent selected from the group consisting of F, Cl, Br, I, and any combination thereof. In some variations, a WCA may have a plurality of halogen atom substituents, such as two or more fluorine atom substituents. The WCAs may also incorporate ligands including non-halogenated, partially or fully halogenated aliphatic or aromatic groups. In some variations, a substituent is selected from the group consisting of linear, branched-chain, or cyclic C1-C18 alkyl or fluoroalkyl groups, and any combination thereof. In some variations, a WCA may have one or more substituents selected from the group consisting of halogens, hydrogen, C1-C18 alkyl groups, and any combination thereof. In some variations, the C1-C18 alkyl groups are selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof.

### Composition of WCAs

SAMIs with high cationic mobility can be prepared from mixtures of at least two different WCA salts that share the same structural core, wherein the salts are in direct contact with each other. This concept transforms common salts incorporating a WCA into super cationic solid conductors that can be used in electrochemical storage devices. Currently, there are limitations in the number of available families of solid-state materials with supercationic conductivities exceeding 10⁻⁴ S/cm. This new concept introduces a new path to achieve superionic conductivity from poorly conducting or non-conducting salts.

Formation of SAMIs occurs through combining a plurality of WCA salts, each having a same core group of atom(s) but differing in one or more substituents (also referred to herein as “ligands”) of the core group of atom(s). By way of chemical and size similarities between all of the WCAs present in each of the parent WCA salts, formation of a SAMI that incorporates these WCAs, where WCA mixing occurs, becomes possible. By way of the differences in chemical nature of bonded ligands present on each of these WCAs, which causes differences in the distribution of electronic densities on these WCAs, the resultant SAMI may have different structural packing features vs. the parent WCA salts. These SAMIs exhibit local structural features that allow for cationic diffusivity, such as expanded lattice volume, local positional disorders, and dissimilar anion-cation interactions.

Without being bound by theory, it is believed that the cations in the parent WCA salts are trapped within deep potential energy wells, restricting cation hopping and leading to low ionic conductivity; while a mixed anionic structure introduces heterogeneities that disrupt the uniform potential energy surface, flattening the site-to-site energy barriers and preventing the cations from settling into deep traps, including the occurrence of expanded volume that results in new structural rearrangements and introduces disorder.

When the cationic transport is not available in the parent WCA salts, cationic transport is at least on the order of or greater than 10⁻⁶ S/cm in the resultant salt mixture. For the case where the cationic transport is present but minimal in the parent WCA salt(s), it is at least one order of magnitude greater in the resultant salt mixture. This concept allows for transforming non-cationic conductors or poorly cation-conducting parent WCA salts into super cationic conductors, including common inorganic or organic salts. The ligands can be judiciously adjusted to obtain the desired balance in electrochemical, physicochemical, and chemical properties. In some variations, halogen functionalities are included to allow for enhanced electrochemical stabilities.

Solid-state electrolytes of the present disclosure include a SAMI having a plurality of WCA salts, i.e., a metal cation, and a plurality of WCAs having a same core group of atom(s) but each with different substituents. The different substituents present in these WCAs can be: 1) a shared substituent present in all the WCAs but different in their number per WCA, such as, but not limited to, halogen, hydrogen, aliphatic or aromatic functionalities, 2) a substituent not shared between all WCAs, for example, one WCA can only have hydrogen functionalities, such as for LiCB11H12, while another WCA can have other nonshared substituents with LiCB₁₁H₁₂, such as fluorine in LiCB₁₁H₁₁F, and/or 3) a substituent having a number and a type shared between all of the WCAs but different in their positions upon the WCA structure. The SAMI of the solid-state electrolytes may be crystalline or semi-crystalline. The SAMI may have a cationic conductivity that is one to four orders of magnitude greater than a cationic conductivity of a corresponding salt comprising the metal cation and any WCA of the plurality of WCAs alone.

SAMIs may have various compositions of WCAs. In some variations, each WCA is present in the plurality of WCAs at 0.5 mol % to 90 mol %. In some variations, a first WCA is present at 5 mol % or greater. In some variations, a first WCA is present at 10 mol % or greater. In some variations, a first WCA is present at 40 mol % to 80 mol %. In some variations, a plurality of WCAs consists of two WCAs. In some variations, a plurality of WCAs consists of three WCAs. In some variations, SAMIs having a first WCA present at 40 mol % to 80 mol % have a cationic conductivity that is at least two orders of magnitude greater than a cationic conductivity of a corresponding SAMI comprising any one of the plurality of WCAs alone. The concentrations of a first, a second, a third, or a fourth anion may each be in the range of 0.5-90 mol %.

### Methods of Preparing SAMIs and Solid-State Electrolytes

To form supercationic conducting SAMIs of the present disclosure, a plurality of parent WCA salts (incorporating a metal cation as described herein and a plurality of WCAs having a core group of atom(s) combined with one or more different functionalities (e.g., ligands) as described herein) are combined through a mechanochemical treatment method. In other embodiments, the plurality of parent WCA salts are combined using a solution-based synthesis. This method comprises dissolving the plurality of parent WCA salts in a common solvent or mixture of solvents to achieve a homogeneous liquid mixture, followed by solidification. Solidification may be achieved through solvent removal (e.g., evaporation or drying) or by precipitation via the addition of one or more non-solvents (antisolvents). The resulting SAMI incorporates these structurally similar WCAs. The structure of this SAMI (e.g., a crystalline or semi-crystalline structure) can be inherited from either of the parent WCA salts or can exhibit a different structure. This resultant SAMI incorporating these mixed WCAs exhibits a cationic mobility of at least one of the various metal cations (e.g., Li⁺, Na⁺, K⁺, Mg²⁺, Ca²⁺, Zn²⁺, Al³⁺, and any combination thereof). The SAMI can be used in solid-state electrolyte compositions of the present disclosure, e.g., in electrochemical devices such as primary or secondary batteries.

In some variations, methods further include heating of the SAMI. In some variations, further heating treatment may occur at a temperature of up to 500° C. In some variations, further heating may occur at a temperature of 200° C. or less. In some variations, the heating step increases the cationic conductivity of the SAMI by at least one order of magnitude. In some variations, methods further include homogenizing the SAMI by ball milling. In some variations, methods include forming a solid-state electrolyte comprising the SAMI. In some variations, forming a solid-state electrolyte includes applying pressure to the SAMI.

SAMIs Prepared from Metal Salts of Boron Cluster Anions

Disclosed herein are fluorine-functionalized chemistries-particularly boron-fluorine motifs-which can be highly stable yet fall outside PFAS classifications. As a model system to demonstrate SAMI ASSEs, boron cluster salts are described, as their covalently bonded anions remain discrete in solution, preserving well-defined, synthetically accessible sites. Several boron clusters also exhibit high thermodynamic stability, supporting tolerance to high voltages and enhanced thermal robustness.

Described herein is the transformation of poorly conducting WCA salts (e.g., carbaborate-based salts, e.g., LiCB₁₁H₁₂) into super cationic conductors (SAMIs) that combine a wide electrochemical stability with mechanical softness and low densities. The SSEs show outstanding compatibility with Li metal at (critical current density of 3 mA/cm²)—exceeding the leading sulfide SSEs—and an anodic stability exceeding 4 V, enabling cycling a high loading Li metal anode/4 V class oxide cathode for greater than 500 cycles with very high efficiency exceeding 99.5%). Unlike all known batteries utilizing other inorganic SSE, this system operates using a single SSE, without electrode active material coatings, multiple electrolytes, liquid anolytes or thermal processing, exemplifying the transformative advantage of this new SSE design approach.

Further, the present disclosure further provides electrolytes with low activation energies (i.e., less than 0.6 eV) that include a SAMI having a cationic conductivity that is at least one order of magnitude greater than a cationic conductivity of one of the WCA salts of the SAMI, and low activation energies at room temperature (i.e., 20-22° C.). In addition, electrolytes according to the teachings of the present disclosure can exhibit and/or maintain relatively low activation energies even after cooling to sub-ambient temperatures.

In some variations of the present disclosure, one of the WCA salts is a halogen-free boron cluster salt including a cation selected from Li⁺, Na⁺, K⁺, Mg²⁺, Ca²⁺, Zn²⁺, Al³⁺, and any combination thereof, and a boron cluster anion with the structure [B_{y}H_{(y-z)}R_{z}]²⁻, [CB(_{y-1})H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, and where y is an integer within a range of 6 to 12, (z) is an integer within a range of 0 to y, (t) is an integer within a range of 0 to (y−1), and R is a C1-C18 alkyl group selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof. And in at least one variation, another of the WCA salts is a halogenated boron cluster salt including a cation selected from Li⁺, Na⁺, K⁺, Mg²⁺, Ca²⁺, Zn²⁺, Al³⁺, and any combination thereof, and a boron cluster anion with the structure [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12, (z+i) is an integer within a range of 0 to y, (t+j) is an integer within a range of 0 to (y−1), X is F, Cl, Br, I, or a combination thereof, and R is a C1-C18 alkyl group selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof. In the alternative, X is a halogenated alkyl group containing CF₃. For example, in some variations the boron cluster anion of the halogen-free boron cluster salt and/or the halogenated boron cluster salt is B₁₂H₁₂⁻², B₁₀H₁₀⁻², CB₁₁H₁₂⁻¹ or CB₉H₁₀⁻¹, or a substituted derivative thereof. It should be understood that the large sizes of the boron cluster anions, such as B₁₂H₁₂⁻², B₁₀H₁₀⁻², CB₁₁H₁₂⁻¹, and CB₉H₁₀⁻¹, are attractive for solid-state batteries since such anions display orientation mobility and a dynamic frustration that allows order-disorder phase transitions, which in turn leads to high cation mobility for enhanced ion conduction.

A cation of the halogen-free boron cluster salt can be the same or different than a cation of the halogenated boron cluster salt. Accordingly, an electrolyte formulation with the composite salt mixture can include multiple different boron cluster anions and multiple different cations. The mole percentage (mol %) of the Li⁺, Na⁺, K⁺, Mg²⁺, Ca^{2+, Zn2+, and/or Al3+ cation(s) of the total cations in the e}lectrolyte can be from about 1 to about 100 percent, and the mole percentage of boron cluster anions of all anions of the electrolyte can be from about 0.5 to about 100 percent.

In some variations, a solid-state electrolyte including the SAMI can include one or more additional cation conductivity-enhancing anions. A mol % of the one or more additional conductivity-enhancing anion to the total anions in the composite salt mixture can be from about 0.01 to about 0.9. Also, the one or more additional conductivity-enhancing anions can be selected from F⁻, Cl⁻, Br⁻, I⁻, RₓBF₄₋ₓ⁻, R_{y}PF_{6-y}⁻, SbF₆⁻, ClO₄⁻, SO₄⁻², N(SO₂F)₂⁻, N(SO₂(CF₂)ₙCF₃)₂⁻, [NSO₂(CF₂)ₙ₊₁SO₂]⁻, or CF₃(CF₂)~SO₃⁻, where: n is 0 to 5; x is 0 to 4; y is 0 to 6; and R is a C1-C18 alkyl group selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof.

In at least one variation, a solid-state electrolyte is formulated from the combined WCA salts (e.g., halogen-free boron cluster/halogenated boron cluster salts) with an addition of an organic plastic crystal such that a soft solid-state electrolyte with appreciable cation conductivity (or conductivities) is provided. The organic plastic crystal material can be a succinonitrile-glutaronitrile mixture where the mole percent of glutaronitrile is 15 to 96 mole %, and the plastic state (i.e., the organic plastic crystal) promotes cation conductivities of more than 10-7 S/cm at 60° C. And in some variations, the solid-state electrolyte includes the combined halogen-free boron cluster/halogenated boron cluster salt, the organic plastic crystal, and the one or more additional cation conductivity-enhancing anions.

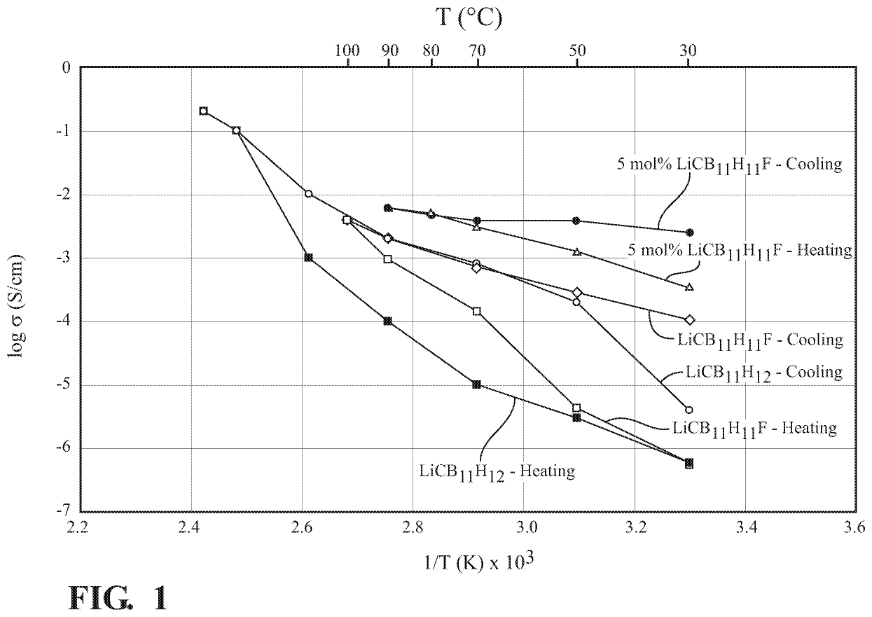

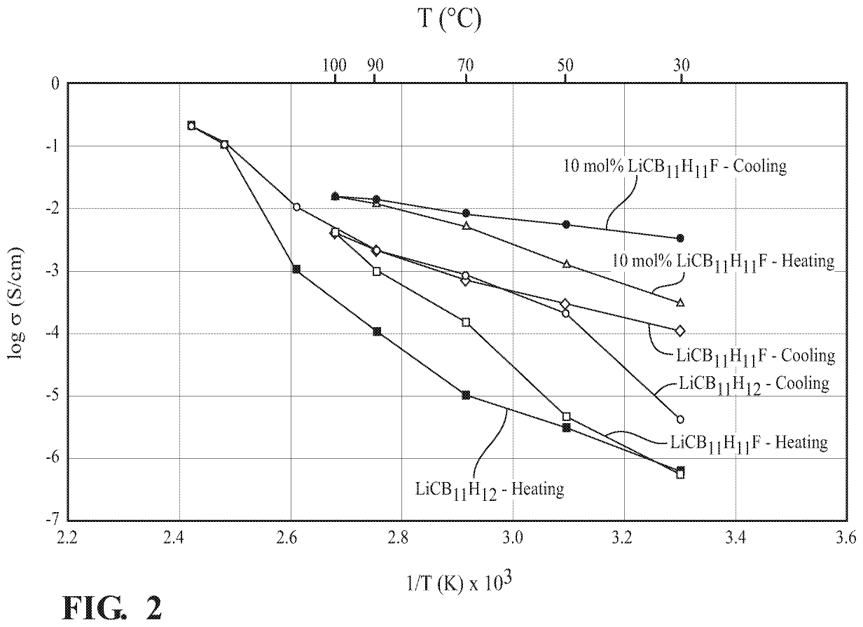

Referring now to FIGS. 1 and 2, Arrhenius plots of conductivity versus temperature for SAMIs prepared from lithium WCA (“LiWCA”) salts according to the teachings of the present disclosure are shown. Particularly, FIG. 1 shows an Arrhenius plot for a combined 95 mol % LiCB₁₁H₁₂ (“LiWCA-1”)-5 mol % LiCB11H11F (“LiWCA-2”) salt subjected to cationic conductivity measurements at 30, 50, 70, 80, and 90° C. during heating of the combined 95 mol % LiWCA-1-5 mol % LiWCA-2 salt (labeled “5 mol % LiCB₁₁H₁₁F-Heating”) and cationic conductivity measurements at 90, 80, 70, 50, and 30° C. following the heating of the combined 95 mol % LiWCA-1-5 mol % LiCB₁₁H₁₁F salt (labeled “5 mol % LiCB₁₁H₁₁F-Cooling”). FIG. 2 shows an Arrhenius plot for a combined 90 mol % LiWCA-1-10 mol % LiWCA-2 salt subjected to cationic conductivity measurements at 30, 50, 70, 90, and 100° C. during heating (labeled “10 mol % LiCB₁₁H₁₁F-Heating”) and cationic conductivity measurements at 100, 90, 70, 50, and 30° C. following the heating of the combined 90 mol % LiWCA-1-10 mol % LiWCA-2 salt (labeled “10 mol % LiCB₁₁H₁₁F-Cooling”). And for comparison, FIGS. 1 and 2 also show cationic conductivities for neat LiWCA-1 during heating.

The combined 95 mol % LiWCA-1-5 mol % LiWCA-2 salt and the combined 90 mol % LiCB₁₁H₁₂/10 mol % LiWCA-2 salt were prepared by mixing LiWCA-1 and LiWCA-2 salts with a mortar and pestle, followed by ball milling at 700 revolutions per minute (RPM) for 24 hours to ensure uniformity of the combined LiWCA-1-LiWCA-2 salts. A solid-state electrolyte pellet for each of the combined LiWCA-1-LiWCA-2 salts was formed by pressing a given LiWCA-1-LiWCA-2 salt mixture at a pressure of at least 120 MPa. Also, carbon-coated aluminum foil was used as the working electrode and the counter electrode of a two-electrode cell, and a solid-state electrolyte pellet of the combined 95 mol % LiWCA-1-5 mol % LiWCA-2 salt or the combined 90 mol % LiWCA-1-10 mol % LiWCA-2 salt was in direct contact with the working and counter electrodes during cationic conductivity measurements.

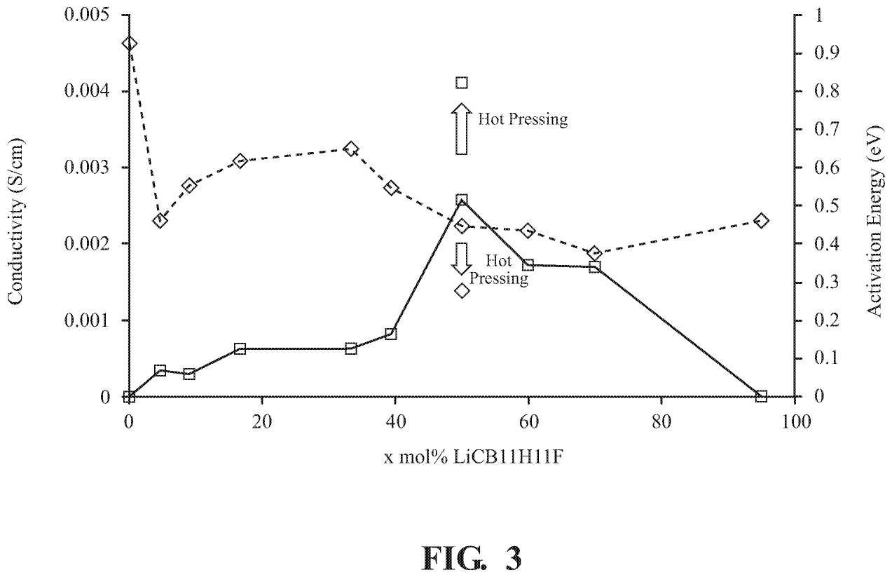

Referring particularly to FIG. 1, the combined 95 mol % LiWCA-1-5 mol % LiWCA-2 salt exhibited cationic conductivities of about 3.6×10⁻⁴ S/cm at 30° C. initially and of about 2.2×10⁻³ S/cm at 30° C. after heating. In contrast, the neat LiWCA-1 salt exhibited cationic conductivities initially of about 6.0×10⁻⁷ S/cm at 30° C. and about 4.0×10⁻⁶ at 30° C. after heating. Accordingly, an increase in cationic conductivity of the combined 95 mol % LiWCA-1-5 mol % LiWCA-2 salt after heat treatment was observed. An extremely low activation energy of less than 0.5 eV was observed for the combined 95 mol % LiWCA-1-5 mol % LiWCA-2 salt at 30° C. (see FIG. 3). The cationic conductivity of the combined 95 mol % LiWCA-1-5 mol % LiWCA-2 salt at 30° C. was greater than about 500 to 1000 times the cationic conductivity of the LiWCA-1.

Referring particularly to FIG. 2, the combined 90 mol % LiWCA-1-10 mol % LiWCA-2 salt exhibited cationic conductivities initially of about 3.2×10⁻⁴ S/cm at 30° C. and about 3.2×10⁻³ S/cm at 30° C. following the heating cycle. In contrast, and as noted above, the neat LiWCA-1 salt exhibited cationic conductivities of about 6.0×10-7 S/cm at 30° C. and about 4.0×10⁻⁶ S/cm at 30° C. following the heating cycle. Accordingly, an increase in cationic conductivity of the combined 90 mol % LiWCA-1-10 mol % LiWCA-2 salt was observed. An extremely low activation energy of less than 0.6 eV was observed for the combined 90 mol % LiWCA-1-10 mol % LiWCA-2 salt at 30° C. (see FIG. 3). The cationic conductivity of the combined 90 mol % LiWCA-1-10 mol % LiWCA-2 salt at 30° C. was greater than about 500 to 1000 times the cationic conductivity of the LiWCA-1.

Referring now to FIG. 3, a plot of conductivity at 30° C. (solid line) and activation energy (dashed line) calculated from the temperature range 30-60° C. for a plurality of LiWCA-1-LiWCA-2 compositions is shown. The compositions were cold pressed and not subjected to thermal activation, except for the two data points shown for a 50 mol % LiWCA-1-50 mol % LiWCA-2 composition. As observed from FIG. 3, the conductivity of 100 mol % LiWCA-1 and 5 mol % LiWCA-1-95 mol % LiWCA-2 (solid line) is very low compared to desired compositions of LiWCA-1 and LiWCA-2. For example, compositions such as 50 mol % LiWCA-1-50 mol % LiWCA-2 can be greater than 1000 times that of 100 mol % LiWCA-1 and greater than 1000 times that of 100 mol % LiWCA-2. In addition, the plot of conductivity versus composition illustrated a specific range or “sweet spot” of compositions that provide enhanced conductivity at 30° C. In some variations, the range of compositions that provide enhanced conductivity is between about 60 mol % LiWCA-1-40 mol % LiWCA-2 and about 20 mol % LiWCA-1-80 mol % LiWCA-2, while in other variations the range is between about 55 mol % LiWCA-1-45 mol % LiWCA-2 and about 25 mol % LiWCA-1-75 mol % LiWCA-2. And in at least one variation, the range of compositions that provide enhanced conductivity is between about 55 mol % LiWCA-1-45 mol % LiWCA-2 and about 30 mol % LiWCA-1-70 mol % LiWCA-2. In addition, the 50 mol % LiWCA-1-50 mol % LiWCA-2 composition was further hot pressed, and this hot-pressed composition exhibited an even higher conductivity (almost two times greater) compared to the 50 mol % LiWCA-1-50 mol % LiWCA-2 composition without hot pressing.

Still referring to FIG. 3, all of the tested LiWCA-1-LiWCA-2 compositions exhibited an activation energy less than 0.65 eV at 30° C. In some variations (i.e., for some compositions), the activation energy was less than 0.61 eV, while in other variations the activation energy was less than 0.58 eV. In at least one variation, the activation energy was less than 0.51 eV, and in some variations the activation energy was less than 0.47 eV, for example, less than 0.42 eV and less than 0.40 eV. And for the 50 mol % LiWCA-1-50 mol % LiWCA-2 composition that was further hot-pressed, this sample exhibited an activation energy less than 0.33 eV.

It should also be understood from FIGS. 1, 2, and 3 that the SAMIs prepared from WCA salts according to the teachings of the present disclosure have or exhibit a cationic conductivity that is at least one order of magnitude greater than a cationic conductivity of one or both of the parent WCA salts. In some variations, the SAMIs according to the teachings of the present disclosure have or exhibit a cationic conductivity that is at least two orders of magnitude greater than the cationic conductivity of one or both of the parent WCA salts. And in at least one variation, the SAMIs according to the teachings of the present disclosure have or exhibit a cationic conductivity that is between two and three orders of magnitude greater than the cationic conductivity of one or both of the parent WCA salts, and an activation energy less than 0.65 eV, e.g., less than 0.55 eV, less than 0.45 eV, and/or less than 0.35 eV. In some variations, SAMIs according to the teachings of the present disclosure exhibit a cationic conductivity on the order of 10⁻⁵ S/cm to 10⁻¹ S/cm at temperatures ranging from about 30° C. to about 100° C.

### Electrochemical Cells

In some variations, an electrochemical cell as described herein includes an anode, a cathode, and an electrolyte including a SAMI as described herein. In one form of the present disclosure, the electrolyte including the SAMI is a solid-state electrolyte for a solid-state electrochemical device. In another form of the present disclosure, an electrolyte including the SAMI is in a partially liquid molten state at room temperature (i.e., 20-25° C.). And in still another form, an electrolyte including the SAMI is in a fully liquid molten state at room temperature.

In some variations, an electrolyte includes a SAMI prepared by combining or mixing appropriate amounts of a plurality of parent WCA salts using mechanochemical synthetic ball milling followed by an optional heat treatment of the ball-milled material at temperatures less than 500° C. and an optional ball milling homogenization step. In other variations, an electrolyte includes a SAMI prepared using solution-based synthesis in which appropriate amounts of a plurality of parent WCA salts are dissolved in a solvent (e.g., an ether solvent) followed by a solvent removal step and an optional ball milling homogenization step.

In some variations, an electrochemical device including an anode, a cathode, and an electrolyte with the SAMI in contact with the anode and the cathode is provided in the present disclosure. The electrochemical device can be a secondary battery or a subunit of a secondary battery or a primary battery. The anode is an electrode where alkali metal or alkali earth metal oxidation occurs during the device's discharge and where reduction occurs during the device's charge. Similarly, the cathode is an electrode where a cathode material reduction occurs during the device's discharge and a cathode material oxidation occurs during the device's charge.

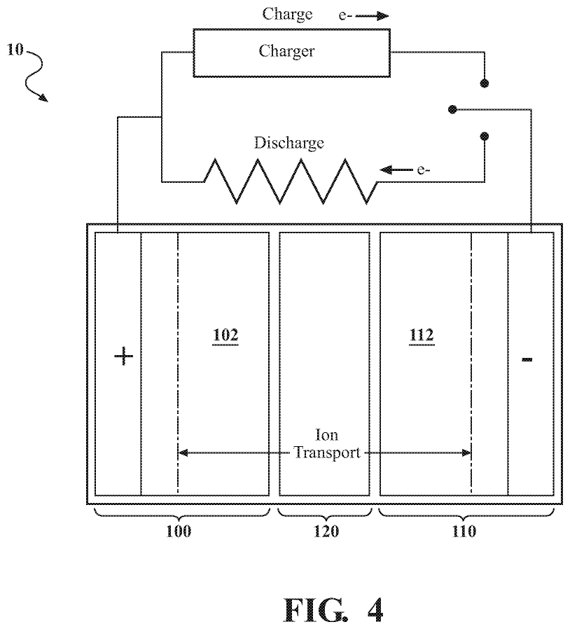

Referring now to FIG. 4, an electrochemical device 10 according to the teachings of the present disclosure is shown. In some variations, the electrochemical device 10 is a solid-state electrolyte (SSE) electrochemical device that includes a cathode 100, with or without a catholyte 102, an anode 110, with or without an anolyte 112, and a cell separator (also referred to herein simply as a “separator”) 120. It should be understood that the separator 120 electrically isolates the cathode 100 from the anode 110, but allows ionic conduction therebetween. In some variations, the separator 120 functions as both a ‘separator” between the cathode functions as both a ‘separator’ between the cathode 100 and the anode 110, and as a solid-state electrolyte for the electrochemical device 10. In other variations, a solid-state electrolyte can be present between the cathode 100 and the anode 110, in addition to the separator 120.

The cathode 100 can be an insertion cathode, a conversion cathode, or an organic cathode, and the anode 110 can be an intercalation anode, a metal anode, an alloy anode, or an organic anode. The electrochemical device 10 includes the solid-state electrolyte according to the teachings of the present disclosure, which includes a SAMI including a metal cation selected from Li⁺, Ca²⁺, K⁺, Mg²⁺, Ca²⁺, Zn²⁺, Al³⁺, and any combination thereof, and a plurality of WCAs as disclosed herein.

In some variations, the solid-state electrolyte as disclosed herein is used as the separator 120, is present in the catholyte 102, and/or is present in the anolyte 112 of the electrochemical device 10. As used herein, the term “catholyte” refers to a solid-state electrolyte blended in a cathode to enable and/or enhance cationic diffusion in the cathode electrode structure, and the term “anolyte” refers to a solid-state electrolyte blended in an anode to enable and/or enhance cationic diffusion in the anode electrode structure.

In at least one variation, the separator 120 is not formed from the inorganic SAMI solid-state electrolyte as disclosed herein. Non-limiting examples of such electrolytes include sulfide solid-state electrolytes, hydride solid-state electrolytes, polymer solid-state electrolytes, oxide solid-state electrolytes, halide-type solid-state electrolytes, plastic crystal solid-state electrolytes, inorganic-organic crystal plastic solid-state electrolytes, and combinations thereof.

In some variations, the catholyte 102 can be formed only from the solid-state electrolyte including the SAMI as disclosed herein, or in the alternative the catholyte 102 can include the solid-state electrolyte including the SAMI as disclosed herein in combination with another solid-state electrolyte, that is not the solid-state electrolyte including the SAMI, such as sulfide solid-state electrolytes, hydride solid-state electrolytes, polymer solid-state electrolytes, oxide solid-state electrolytes, halide-type solid-state electrolytes, plastic crystal solid-state electrolytes, inorganic-organic plastic crystal solid-state electrolytes, and combinations thereof.

Similarly, the anolyte 112 can be formed only from the solid-state electrolyte including the SAMI as disclosed herein, or in the alternative the anolyte 112 can include the solid-state electrolyte including the SAMI as disclosed herein in combination with other solid-state electrolytes that are not solid-state electrolytes including a SAMI, such as sulfide solid-state electrolytes, hydride solid-state electrolytes, polymer solid-state electrolytes, oxide solid-state electrolytes, halide-type solid-state electrolytes, plastic crystal solid-state electrolytes, inorganic-organic plastic crystal solid-state electrolytes, and combinations thereof.

The inorganic boron cluster solid-state electrolyte in the electrochemical device 10 exhibits high compatibility with the anode 110, including metallic anodes such as Li, Na, K, Mg, Ca, Zn, and Al, alloy anodes such as Si and Sn alloy anodes, conversion anodes, organic anodes, and intercalation anodes such as graphite anodes. For example, the solid-state electrolyte including the SAMI supports a cycling coulombic efficiency (CE) greater than 90% with the above-noted anodes. The solid-state electrolyte including the SAMI also exhibits high compatibility with the cathodes noted above, e.g., a conversion cathode such as a sulfur cathode.

### SAMI ASSE Crystal Structure and Cationic Mobility

Composite salt mixtures as described herein may have various crystalline structures. In some variations, the composite salt mixture has a crystalline or semi-crystalline structure. In some embodiments, crystalline or semi-crystalline composite salt mixtures have an orthorhombic crystal lattice structure as shown by x-ray diffraction (XRD). In some variations, a composite salt mixture has a crystal lattice cell volume which is about 1% to about 20% greater, such as about 4% to about 9% greater, than that of a corresponding composite salt mixture including a metal cation and any WCA of the plurality of WCAs alone. In some embodiments, a composite salt mixture has a cationic conductivity that is one to four orders of magnitude greater than a cationic conductivity of a corresponding composite salt mixture including a metal cation and any WCA of the plurality of WCAs alone.

The exemplary WCA salt, LiCB₁₁H₁₂, has a very low cationic conductivity at room temperature; however, it only transforms into a super cationic conductor at temperatures greater than 120° C. through a reversible structural transformation from an orthorhombic to a cubic phase (as determined by x-ray diffraction (XRD)) in order to achieve appreciable room temperature conductivities in LiCB₁₁H₁₂, or at room temperature through incorporating a different anion in the LiCB₁₁H₁₂ structure, such as CB9H10 (but at a cost: the inclusion of the less stable anion reduces the intrinsic ~4.2 V anodic stability of CB11H12-) yet still does not deliver Li-metal compatibility on par with leading systems such as argyrodite-type SSEs.

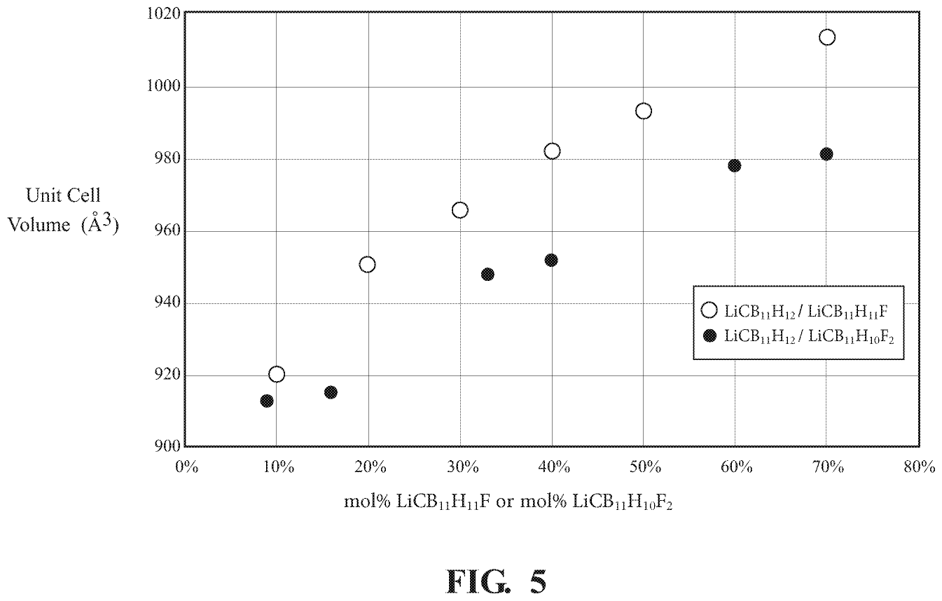

Generally, the substitution of a hydrogen atom with a halogen such as I or Cl on a CB11H12− anion negatively impacts this transformation. Fluorinated salts with targeted installation of one or two fluorine atoms (LiCB₁₁H₁₁F and LiCB₁₁H₁₀F₂) have been prepared. However, room temperature Li conductivities were significantly degraded in these salts, i.e., about halved in LiCB₁₁H₁₁F and down to immeasurable values in LiCB11H10F2. The fluorine-induced suppression of Li⁺ mobility is also mirrored in halide SSEs, where it enforces an unfavorable tradeoff between the conductivity and electrochemical robustness. Owing to their closely matched structure and sizes, mixtures of CB11H12− and its partially fluorinated anions readily formed solid-state solutions. All these SAMIs were crystalline (as determined by XRD) and inherited the orthorhombic room temperature phase of LiWCA-1 (see FIG. 5). Regarding FIG. 5, calculated cell volume for SAMIs of LiWCA-1-LiWCA-2 and of LiWCA-1-LiWCA-3 was observed to increase with increasing molar % of each of LiWCA-2 and LiWCA-3, particularly in the range of 50-70 molar %. Composite salt mixtures with LiWCA-2 or LiWCA-3 displayed about a 1% to about a 20% greater crystal lattice cell volume, as compared to the corresponding composite salt mixture comprising any of the plurality of WCAs alone.

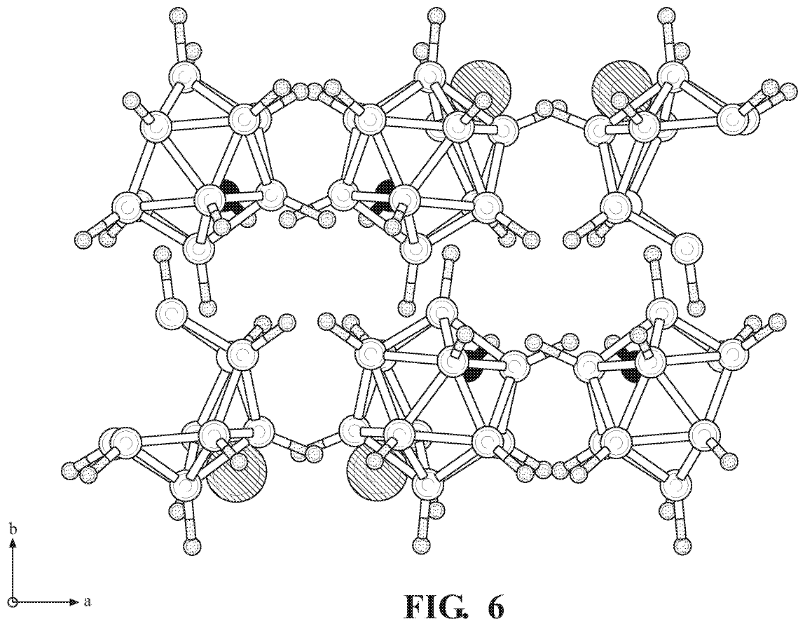

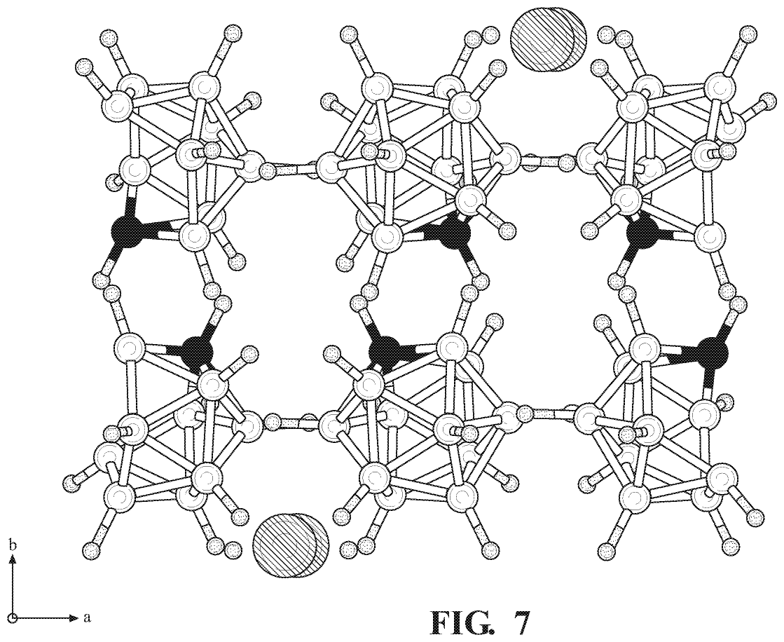

FIG. 6 shows the experimentally determined (by XRD at 30° C.) crystal structure for a solid-state solution of 40 mol % LiWCA-1-60 mol % LiCB₁₁H₁₁F, which adopts the orthorhombic structure of LiWCA-1, while FIG. 7 shows the experimentally determined (by XRD at 30° C.) crystal structure for a solid-state solution of 30 mol % LiWCA-1-70 mol % LiCB₁₁H₁₁F, which also retains the orthorhombic structure of LiWCA-1. For FIGS. 6-7, the balls filled with a diagonal pattern are lithium cations (Li⁺), the white balls are boron (B) atoms, the solid balls are carbon (C) atoms, with B and C atoms connected as the vertices of the three-dimensional boron cluster structure, the balls filled with a dotted pattern are H or F atoms (due to the random intermixing of the anions within the solid-state solution lattice, these positions represent a statistical occupancy of H and F rather than fixed atomic assignments).

It is surprising to find that increasing fluorine content has led to lattice expansion as this is contrary to trends in fluorine-containing SSEs, where strong interactions between the acidic Li cation and the electronegative F− anion typically lead to volume contraction as was reported in halides SSE. These SAMIs feature a low room temperature density at around 1 g/cm³, which is advantageous for solid-state battery design as lighter SSEs reduce energy-density penalties associated with the use of heavy electrolytes. The resultant SAMIs display at least one order of magnitude increase in the Li⁺ conductivity vs. the parent WCA salts, accompanied by low activation energy, with supercationic conductivity peaking in the range between 50-70% LiWCA-2 (see FIG. 3). A similar trend was observed for LiWCA-3. The conductivity increase trend correlates with the lattice volume increase trend (i.e., free volume increase trend, see FIG. 5), a well-established driver to enhanced cationic mobility. The ease of forming these SAMIs achieving superionic Li⁺ mobilities while preserving the parent WCA salt's framework-offers a potent design strategy to broaden the landscape of inorganic solid-state conductors.

The preceding description is merely illustrative in nature and is in no way intended to limit the disclosure, its application, or uses. As used herein, the phrase “at least one of A, B, and C” should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein, the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A solid-state electrolyte composition comprising:
a composite salt mixture comprising:
a metal cation selected from the group consisting of Li⁺, Na⁺, K⁺, Mg²⁺, Ca²⁺, Zn²⁺, Al³⁺, and any combination thereof; and
a plurality of weakly coordinating anions (WCAs) comprising 0.5 mole percent (mol %) to 90 mol % of each WCA thereof, each WCA:
comprising a same core group of atom(s); and
differing from any other WCA thereof in a number, a type, and/or a position of a substituent of the core group of atom(s),
the composite salt mixture comprising a cationic conductivity that is one to four orders of magnitude greater than a cationic conductivity of a corresponding salt comprising the metal cation and any WCA of the plurality of WCAs alone.

2. The solid-state electrolyte according to claim 1, wherein the plurality of weakly coordinating anions (WCAs) are selected from the group consisting of boron cluster anions, sulfonylimide anions, phosphate-based anions, triflate-based anions, phosphorylimide-based anions, organoborate-based anions, organoaluminate-based anions, haloaluminates, haloborates and any combination thereof.

3. The solid-state electrolyte according to claim 1, wherein:
a weakly coordinating anion (WCA) of the plurality of WCAs comprises one to twelve substituents; and/or
the substituent is selected from the group consisting of halogens, hydrogen, C1-C18 alkyl groups, and any combination thereof,
wherein the C1-C18 alkyl groups are selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, aromatic groups, partially fluorinated aromatic groups, and any combination thereof.

4. The solid-state electrolyte according to claim 1, wherein the substituent comprises a fluorine.

5. The solid-state electrolyte according to claim 1, wherein a first weakly coordinating anion (WCA) of the plurality of WCAs comprises 40 mole percent (mol %) to 80 mol % thereof.

6. The solid-state electrolyte according to claim 5, wherein the composite salt mixture comprises a 1% to a 20% greater crystal lattice cell volume, as compared to a corresponding composite salt mixture comprising the metal cation and any weakly coordinating anion (WCA) of the plurality of WCAs alone.

7. The solid-state electrolyte according to claim 5, wherein the composite salt mixture comprises a cationic conductivity that is at least two orders of magnitude greater than a cationic conductivity of a corresponding composite salt mixture comprising the metal cation and any weakly coordinating anion (WCA) of the plurality of WCAs alone.

8. The solid-state electrolyte according to claim 1, wherein the plurality of weakly coordinating anions (WCAs) comprise a boron cluster anion having a structure selected from the group consisting of:
[B_{y}H_{(y-z)}R_{z}]²⁻, [B_{y}H(_{y-z-i)}R_{z}Xᵢ]²⁻, [CB(_{y-1})H_{(y-z)}R_{z}]⁻, [CB(_{y-1})H_{(y-z-i)}R_{z}Xᵢ]⁻,
[C₂B_{(y-2)}H_{(y-t-1)}Rₜ]⁻, [C₂B_{(y-2)}H_{(y-t-i-1)}RₜXⱼ]⁻, [C₂B_{(y-3)}H_{(y-t)}Rₜ]⁻,
[C₂B_{(y-3)}H_{(y-t-j)}RₜXⱼ]⁻, [C₂B_{(y-3)}H_{(y-t-1)}Rₜ]²⁻, and [C₂B_{(y-3)}H_{(y-t-j-1)}RₜXⱼ]²⁻, wherein:
y is an integer within a range of 6 to 12;
(z), or, when Xᵢ is present, (z+i), is an integer within a range of 0 toy;
(t) or, when Xⱼ is present, (t+j), is an integer within a range of 0 to (y−1);
X is F, Cl, Br, I, a halogenated alkyl group including CF₃, or a combination thereof; and
R is a C1-C18 alkyl group selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof.

9. The solid-state electrolyte according to claim 8, wherein the composite salt mixture has a cationic conductivity on the order of 10⁻⁵ S/cm to 10⁻¹ S/cm at a temperature of 30° C. to 100° C.

10. An electrochemical cell comprising:
an anode, a cathode, and a solid-state electrolyte comprising:
a composite salt mixture comprising:
a metal cation selected from the group consisting of Li⁺, Na⁺, K⁺, Mg²⁺, Ca²⁺, Zn²⁺, Al³⁺, and any combination thereof; and
a plurality of weakly coordinating anions (WCAs) comprising 0.5 mole percent (mol %) to 90 mol % of each WCA thereof, each WCA:
comprising a same core group of atom(s); and
differing from any other WCA thereof in a number, a type, and/or a position of a substituent of the core group of atom(s),
the composite salt mixture comprising a cationic conductivity that is one to four orders of magnitude greater than a cationic conductivity of a corresponding salt comprising the metal cation and any WCA of the plurality of WCAs alone.

11. The electrochemical cell according to claim 10, wherein the plurality of weakly coordinating anions (WCAs) are selected from the group consisting of boron cluster anions, sulfonylimide anions, phosphate-based anions, triflate-based anions, phosphorylimide-based anions, organoborate-based anions, organoaluminate-based anions, haloaluminates, haloborates and any combination thereof.

12. The electrochemical cell according to claim 10, wherein:
a first weakly coordinating anion (WCA) of the plurality of WCAs comprises one to twelve substituents; and/or
the substituent is selected from the group consisting of halogens, hydrogen, C1-C18 alkyl groups, aromatic groups, partially fluorinated aromatic groups, and any combination thereof,
wherein the C1-C18 alkyl groups are selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof.

13. The electrochemical cell according to claim 10, wherein the substituent comprises a fluorine.

14. The electrochemical cell according to claim 10, wherein a first weakly coordinating anion (WCA) of the plurality of WCAs comprises 40 mole percent (mol %) to 80 mol % thereof.

15. The electrochemical cell according to claim 14, wherein the composite salt comprises a 1% to a 20% greater crystal lattice cell volume, as compared to a corresponding composite salt mixture comprising the metal cation and any weakly coordinating anion (WCA) of the plurality of WCAs alone.

16. The electrochemical cell according to claim 14, wherein the composite salt mixture comprises a cationic conductivity that is at least two orders of magnitude greater than a cationic conductivity of a corresponding composite salt mixture comprising the metal cation and any weakly coordinating anion (WCA) of the plurality of WCAs alone.

17. The electrochemical cell according to claim 16, wherein the plurality of weakly coordinating anions (WCAs) comprise a structure selected from the group consisting of:
[B_{y}H_{(y-z)}R_{z}]²⁻, [B_{y}H_{(y-z-i)}R_{z}Xᵢ]²⁻, [CB(_{y-1})H_{(y-z)}R_{z}]⁻, [CB(_{y-1})H_{(y-z-i)}R_{z}Xᵢ]⁻,
[C₂B_{(y-2)}H_{(y-t-1)}Rₜ]⁻, [C₂B_{(y-2)}H_{(y-t-i-1)}RₜXⱼ]⁻, [C₂B_{(y-3)}H_{(y-t)}Rₜ]⁻,
[C₂B_{(y-3)}H_{(y-t-j)}RₜXⱼ]⁻, [C₂B_{(y-3)}H_{(y-t-1)}Rₜ]²⁻, and [C₂B_{(y-3)}H_{(y-t-j-1)}RₜXⱼ]²⁻, wherein:
y is an integer within a range of 6 to 12;
(z), or, when Xᵢ is present, (z+i), is an integer within a range of 0 to y;
(t) or, when Xⱼ is present, (t+j), is an integer within a range of 0 to (y−1);
X is F, Cl, Br, I, a halogenated alkyl group including CF₃, or a combination thereof; and
R is a C1-C18 alkyl group selected from the group consisting of linear C1-C18 alkyl groups, branched-chain C1-C18 alkyl groups, cyclic C1-C18 alkyl groups, unsubstituted C1-C18 alkyl groups, at least partially fluorinated C1-C18 alkyl groups, at least partially chlorinated C1-C18 alkyl groups, and any combination thereof.

18. The electrochemical cell according to claim 17, wherein the composite salt mixture has a cationic conductivity on the order of 10⁻⁵ S/cm to 10⁻¹ S/cm at a temperature of 30° C. to 100° C.

19. A method comprising:
forming a composite salt mixture by mixing a plurality of salts using mechanochemical synthetic ball milling or solution-based synthesis, the plurality of salts comprising:
a metal cation selected from the group consisting of Li⁺, Na⁺, K⁺, Mg²⁺, Ca²⁺, Zn²⁺, Al³⁺, and any combination thereof; and
a plurality of weakly coordinating anions (WCAs) comprising 0.5 mole percent (mol %) to 90 mol % of each WCA thereof, each WCA:
comprising a same core group of atom(s); and
differing from any other WCA thereof in a number, a type, and/or a position of a substituent of the core group of atom(s),
the composite salt mixture comprising a cationic conductivity that is one to four orders of magnitude greater than a cationic conductivity of a corresponding salt comprising the metal cation and any WCA of the plurality of WCAs alone, and
optionally, heating the composite salt mixture at a temperature of 500° C. or less;
optionally, homogenizing the composite salt mixture by ball milling; and
forming a solid-state electrolyte comprising the composite salt mixture, optionally, by applying pressure to the composite salt mixture.

20. The method of claim 19, wherein the plurality of weakly coordinating anions (WCAs) are selected from the group consisting of boron cluster anions, sulfonylimide anions, phosphate-based anions, triflate-based anions, phosphorylimide-based anions, organoborate-based anions, organoaluminate-based anions, haloaluminates, haloborates and any combination thereof.
